(19) United States
(12) Patent Application Publication
(10) Pub. No.: US 2012/0110991 A1
(43) Pub. Date: May 10, 2012

(54) PUMP ACTUATOR AND METHODS FOR MAKING THE SAME

(75) Inventors: Victor Ribera Turro, Barcelona (ES); Oscar Faneca Llesera, Barcelona (ES)

(73) Assignee: MEADWESTVACO CALMAR, INC., Richmond, VA (US)

(21) Appl. No.: 13/380,534

(22) PCT Filed: Jun. 24, 2010
(86) PCT No.: PCT/US10/39844

§ 371 Date: Jan. 20, 2012

Related U.S. Application Data
(60) Provisional application No. 61/220,647, filed on Jun. 26, 2009.

(51) Int. Cl. F15B 13/00; B28B 7/22

(52) U.S. Cl. 60/325; 264/255

(57) ABSTRACT

An actuator for a pump wherein the actuator may be made of a single molded part or multiple molded parts wherein each part or component may define a portion of the spin mechanics of the actuator.

### CROSS-REFERENCE TO RELATED APPLICATIONS

This application claims priority to and the benefit of U.S. Provisional Application No. 61220647, entitled “PUMP ACTUATOR AND METHODS FOR MAKING THE SAME,” filed Jun. 26, 2009, and incorporates the same herein by reference in its entirety.

### BACKGROUND OF THE INVENTION

1. Field of the Invention

The present invention relates to actuators and more particularly to actuators or dispensing heads used with fluid delivery devices.

2. State of the Art

Generally, a fluid product dispenser includes a container containing a fluid product to be dispensed and a dispensing device attached to or in communication with the container. The dispensing device may include a valve or a pump fastened to the container and having a dispensing opening through which fluid is dispended from the dispensing device. An actuator or dispensing head may be attached to the pump to actuate the pump and to pump fluid from the container through the pump. Such devices are well known and many examples of pumps and dispensing devices are available.

While many different actuators for pumps are available, most include multiple parts. Each of these parts must be manufactured or molded and then assembled into the final actuator unit. In many cases, the costs associated with producing an actuator or pump may be dependent upon the number of parts that are molded and that are assembled to make the device. For instance, many actuators include actuator shells into which an orifice cup may be inserted to supply spin mechanics to a fluid exiting the actuator. Additional parts may be needed to deliver fluid to the orifice cup. Each of the parts, and the assembly of those parts, adds costs to the device. In addition, the size of the actuator may be mandated by the part sizes and the capabilities of the assembly equipment to handle small parts for assembly. In order to avoid higher costs, parts may be made larger than necessary to facilitate assembly. The larger parts are not necessarily aesthetically desirable.

Therefore, it may be beneficial to develop actuators having fewer parts and slimmer or smaller profiles than existing actuators.

### BRIEF SUMMARY OF THE INVENTION

According to embodiments of the invention, an actuator may include a base and a cap portion. The base and cap portion may include spin mechanics formed therein, such as by being molded therein. Assembly of the base and cap portion together provides an actuator that may be used with a pump or dispensing device.

In some embodiments, the base and cap portion may be molded as a single unit or solitary device wherein the base and cap portion are connected by a living hinge or other connection. The cap portion may be folded over onto the base portion and connected to the base portion to form an actuator. In other embodiments, the base and cap may be molded separately.

In various embodiments of the invention, the spin mechanics of the actuator may be formed in the base, the cap, or both the base and the cap of the actuator. When the base and cap are connected together, the spin mechanics may be defined.

In still other embodiments of the invention, an actuator formed of a base and a cap may be overmolded to provide a head shape over the actuator. In some embodiments, a base and cap portion of an actuator may be molded as a single unit. Through mold movement or an external mechanism, the base and cap may be combined, forming the actuator and the actuator may be closed back in the mold for the molding or formation of a head shape over the actuator. In this manner, an actuator having a distinct head shape may be produced. In addition, the overmolding of the actuator to form the head shape may prevent the base and cap from separating.

In still other embodiments of the invention, an actuator may be enclosed or surrounded by a sleeve.

### BRIEF DESCRIPTION OF THE DRAWINGS

While the specification concludes with claims particularly pointing out and distinctly claiming particular embodiments of the present invention, various embodiments of the invention can be more readily understood and appreciated by one of ordinary skill in the art from the following descriptions of various embodiments of the invention when read in conjunction with the accompanying drawings in which:

FIG. 1 illustrates an actuator according to embodiments of the invention;

FIG. 2 illustrates an actuator according to embodiments of the invention;

FIG. 3 illustrates a rear perspective view of an actuator according to embodiments of the invention;

FIG. 4 illustrates a front perspective view of an actuator according to embodiments of the invention;

FIG. 5 illustrates a front perspective view of an actuator according to embodiments of the invention;

FIG. 6 illustrates an actuator sleeve according to embodiments of the invention;

FIG. 7 illustrates a bottom perspective view of the actuator sleeve of FIG. 6;

FIG. 8 illustrates an actuator sleeve fitted over an actuator according to embodiments of the invention;

FIG. 9 illustrates a bottom perspective view of the actuator sleeve and actuator illustrated in FIG. 8;

FIG. 10 illustrates a cross-sectional view of an unassembled actuator according to embodiments of the invention;

FIG. 11 illustrates a cross-sectional view of an actuator being assembled according to embodiments of the invention;

FIG. 12 illustrates an assembled actuator according to embodiments of the invention;

FIG. 13 illustrates a secondary molding process over an assembled actuator according to embodiments of the invention;

FIG. 14 illustrates an actuator and head combination according to embodiments of the invention; and

FIG. 15 illustrates a molding process for an actuator according to embodiments of the invention.

### DETAILED DESCRIPTION OF THE INVENTION

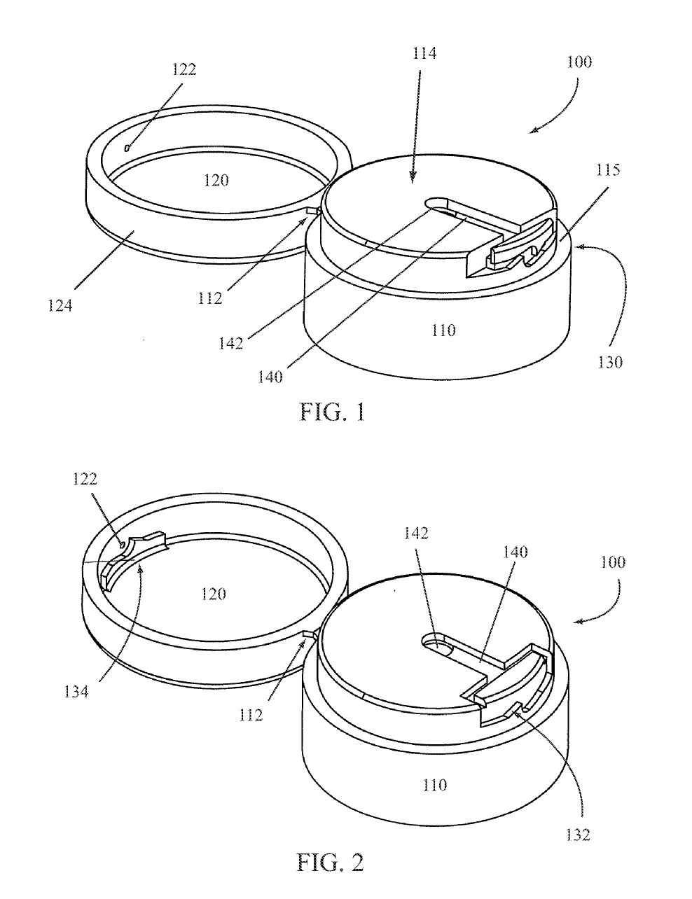

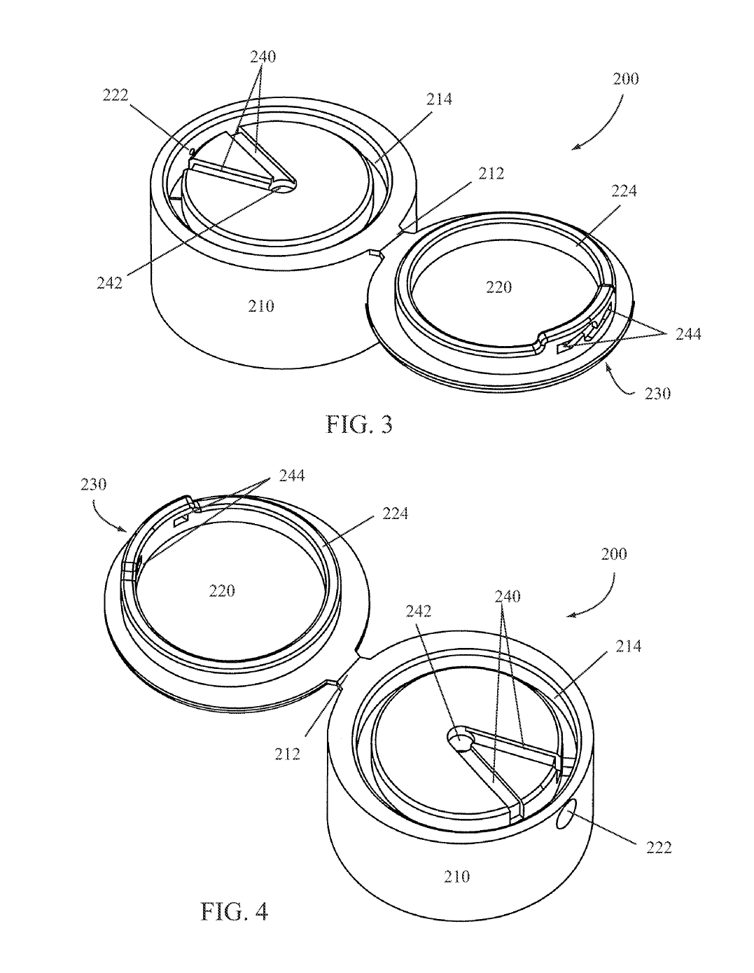

According to various embodiments of the invention, an actuator for a pump may comprise a molded plastic actuator 100 as illustrated in FIG. 1 or 2. The actuator 100 may include a base 110 and a cap 120 wherein the cap 120 may be fitted or secured to the base 110 to form the actuator 100. According to some embodiments of the invention, the base 110 and cap 120 may be molded together as a single unit. In such embodiments, a living hinge 112 connecting the base 110 and cap 120 may allow the cap 120 to be folded over and to fit over a portion of the base 120. The cap 120 may be secured to the base 110 by any known method. According to other embodiments of the invention, the base 110 and cap 120 may be molded as separate components and the cap 120 may be fitted or secured to the base 110 by any known method.

According to some embodiments of the invention, the spin mechanics 130 of the actuator 100 may be molded or formed in the base 110 of the actuator. For example, the spin mechanics 130 of the actuator 100 illustrated in FIG. 1 are formed in the base 110 of the actuator 100. When the cap 120 of the actuator 100 illustrated in FIG. 1 is folded over and fitted to or secured with the base 110, the spin mechanics 130 may be aligned with an orifice 122 in the cap 120. In other embodiments, the spin mechanics 130 may be formed by a combination of a lower spin mechanic portion 132 and an upper spin mechanic portion 134. For example, the spin mechanics 130 may be formed by the positioning of a lower spin mechanic portion 132 in a base 110 of the actuator 100 with an upper spin mechanic portion 134 in a cap 120 of the actuator 100 as illustrated in FIG. 2. When the cap 120 of the actuator 100 illustrated in FIG. 2 is folded over and fitted to or secured with the base 110, the spin mechanics 130 are formed by the positioning of the lower spin mechanic portion 132 and the upper spin mechanic portion 134.

According to embodiments of the invention, when a cap 120 is fitted to a base 110, an orifice 122 or opening in the cap 120 may be in line with the spin mechanics 130 such that a desired spray or distribution pattern of fluid exiting the actuator 100 is achieved. The placement or positioning of the orifice 122 may be altered as desired and may be sized, shaped, or otherwise configured to provide a desired spray pattern in combination with the spin mechanics 130 of the actuator 100.

An actuator 100 according to embodiments of the invention may also include a fluid path opening 142 and one or more fluid paths 140. The fluid path opening 142 and one or more fluid paths 140 may be used or configured to deliver fluid from a pump to the spin mechanics 130 and out of an orifice 122 in the actuator 100. For instance, the actuators 100 illustrated in FIGS. 1 and 2 include a fluid path opening 142 which may be in communication with a pump or fluid flow path. Fluid communicated to, or through, the fluid path opening 142 flows along fluid path 140 and is then distributed or forced through the spin mechanics 130 and out orifice 122. When cap 120 is positioned over base 110, the fluid path 140 is defined such that fluid entering the fluid path 140 may travel along the fluid path 140 to the spin mechanics 130.

According to various embodiment of the invention, the fluid path 140 may branch into two or more paths to deliver fluid to the spin mechanics 130 as illustrated in FIGS. 1 and 2. Although the fluid path 140 illustrated in FIGS. 1 and 2 is shown as being formed completely in the base 110, it is understood that a fluid path 140 may also be formed completely in the cap 120 or may be formed by partial paths formed in the base 110 and the cap 120 which communicate when the base 110 and the cap 120 are joined together to form an actuator 100.

In various embodiments of the invention, the configuration of the cap 120 relative to the base 110 or the configuration of fluid paths 140 through the cap 120, base 110, and spin mechanics 130 may be altered as desired to create a desired turbulence in the fluid flowing through the fluid paths 140. For example, projections, walls, barriers, eddies, and other features may be added to the fluid paths 140 or in the spin mechanics 130 to alter the flow of fluid through the fluid paths 140 and out the actuator 100.

When the actuator 100 illustrated in FIG. 1 is assembled such that the cap 120 fits over the base 120, the actuator 100 may be attached to a pump. Fluid communicated from the pump and through the fluid path opening 142 of the actuator 100 may then flow through fluid path 140 until it splits into two paths feeding the spin mechanics 130. Fluid entering the spin mechanics 130 is forced through the spin mechanics 130 where the fluid may become turbulent before exiting the actuator 100 through an orifice 122 in communication with the spin mechanics 130.

Although particular configurations for the spin mechanics 130 are illustrated in the various Figures herein, it is understood that any desired configuration of the spin mechanics 130 may be used with embodiments of the invention. As illustrated in FIG. 1, the spin mechanics 130 may be configured in the base 110 as desired. The spin mechanics 130 could also be configured or formed in just the cap 120. It is also understood, as illustrated in FIG. 2, that the spin mechanics 130 may be formed from a joining of the base 110 with the cap 120. In any embodiment, the spin mechanics 130 may be produced in any desired shape or form to impart the desired spin or characteristics to fluid exiting the actuator 100.

As illustrated in FIGS. 1 and 2, a base 110 may include a skirt extending up to a shelf 115 or ledge and a recessed portion 114 mounted over the shelf 115 and having a smaller diameter than the remainder of the actuator 100. The spin mechanics 130, fluid path 140, a fluid path opening 142 may be formed in the recessed portion 114 of the base 110. A cap 120 may include a cap rim 124 configured such that an interior portion of the cap rim 124 may abut at least a portion of the recessed portion 114 of the base 110 when the cap 120 is positioned over the base 110. A base portion of the cap rim 124 may rest on the shelf 115 when a cap 120 is fitted to a base 110.

While the actuators 100 illustrated in FIGS. 1 and 2 are round, it is understood that other shapes could also be made according to embodiments of the invention. For instance, a base 110 and cap 120 could have a square, rectangular, oval, triangular, or other shape as desired.

An actuator 200 according to other embodiments of the invention is illustrated in FIGS. 3 and 4. The actuator 200 may include a base 210 and a cap 220 which may be joined together to form an actuator 200 according to embodiments of the invention. The base 210 may include one or more base voids 214 in at least a portion of the base 210 and the cap 220 may include at least one or more cap rims 224. The cap 220 may be fitted to the base 210 such that the one or more cap rims 224 fit into corresponding one or more base voids 214. Fitment or joining of the cap rims 224 with the base voids 214 may help to secure the cap 220 to the base 210.

As illustrated in FIGS. 3 and 4, the base 210 and cap 220 may be joined by a living hinge 212. The living hinge 212 may allow the cap 220 to be folded over, and connected with the base 220. Formation of an actuator 200 having both the base 210 and cap 220 connected as illustrated in FIGS. 3 and 4 allows a single mold to be used to form an actuator 200. However, in other embodiments of the invention, the base 210 and cap 220 may be made separately, such as by two different molds, and combined.

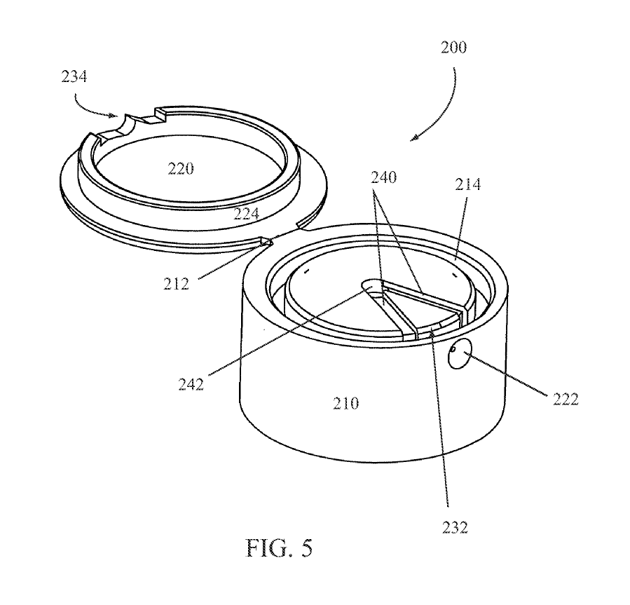

The actuator 200 illustrated in FIGS. 3 and 4 includes spin mechanics 230 formed in a portion of the cap 220. In particular, the spin mechanics 230 may be formed in a portion of the cap rim 214 as illustrated. In other embodiments of the invention, the spin mechanics 230 may be formed in the base 210 or another portion of the cap 220. The spin mechanics 230 may also be formed by the combination of an upper spin mechanic portion 234 located in a portion of the cap 220 and a lower spin mechanic portion 232 located in a portion of the base 210 as illustrated in FIG. 5.

As illustrated in FIGS. 3, 4 and 5, an orifice 222 may be positioned in the base 210 of the actuator 200. The orifice 222 may be configured to match with the spin mechanics 230 of the actuator 200 to produce a desired spray pattern. The actuator 200 may also include one or more fluid paths 240 in communication with the spin mechanics 230 and with one or more fluid path openings 242. The one or more fluid path openings 242 may deliver fluid to the one or more fluid paths 240 from a pump to which the actuator 200 is connected or in communication with.

According to some embodiments of the invention, the cap rim 224 may include one or more fluid path holes 244 through the cap rim 224. When the cap 220 and base 210 are connected, the fluid path holes 244 in the cap rim 224 may allow fluid passing along the fluid paths 240 to flow through the cap rim 224 and into the spin mechanic 230 region of the actuator 200. For example, fluid passing through the fluid paths 240 illustrated in FIGS. 3, 4, and 5, may be distributed through the fluid path holes 244 and into the spin mechanics 230 region before exiting the actuator 200 through the orifice 222.

As with other embodiments of the invention, the actuators 200 illustrated in FIGS. 3, 4, and 5 may include spin mechanics 230 configured to provide a desired spray pattern or profile for the actuator 200. In addition, the cap 220 and base 210 portions of the actuator 200 may be combined or fitted together using any desired means, including snap-fit means, glue, welding, or other securing methods.

The actuators according to embodiments of the invention may also be made or constructed to be smaller than know actuators. For example, many known actuators require the assembly of an orifice cup into the actuator to provide spin mechanics. Because the spin mechanics of the actuators of the present invention are molded or constructed with the base, cap, and/or combination thereof, large openings in the actuator are not necessary to allow for assembly of an orifice cup. Therefore, actuators according to embodiments of the invention may be made smaller than other actuators.

The actuators according to embodiments of the invention may be fitted or configured to fit with any desired pump or pumping device. According to embodiments of the invention, single, molded components wherein a cap and base may be fitted together to form an actuator provide a cheaper alternative to multiple piece actuators. In addition, any variety of spin mechanics may be formed by molding the spin mechanics into the base, the cap, or partially into the base and the cap such that joinder of the base and cap produces a desired spray pattern.

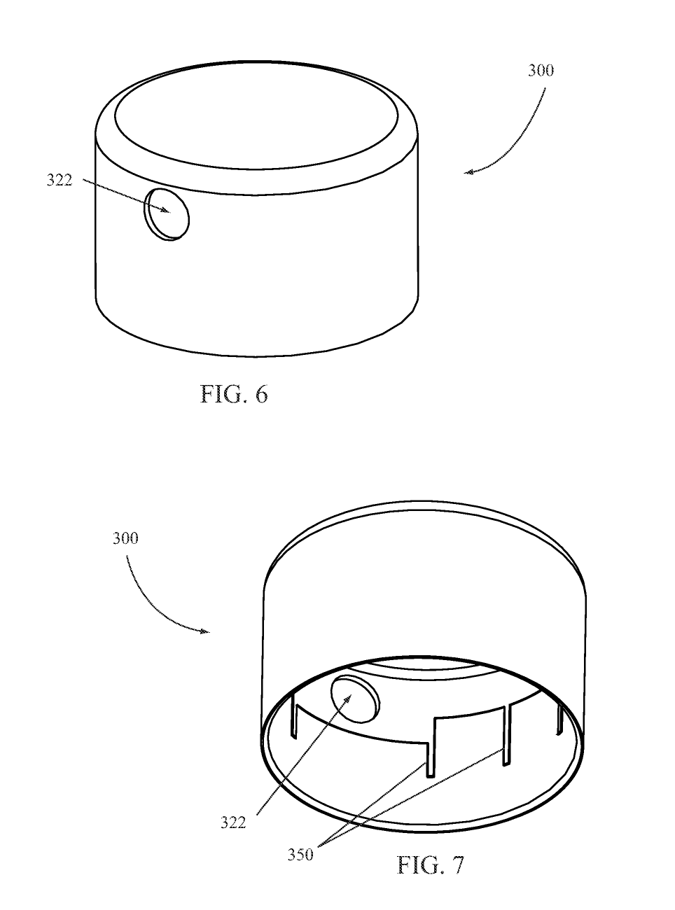

According to other embodiments of the invention, a sleeve 300 may be fitted over an actuator according to embodiments of the invention. For example, the sleeve 300 illustrated in FIGS. 6 and 7 may be fitted over the actuator 100 illustrated in FIGS. 1 and 2 or over the actuator 200 illustrated in FIGS. 3, 4, and 5. An orifice hole 322 may be configured to be positioned over an orifice of an actuator such that the orifice of the actuator is not blocked. The sleeve 300 may also include one or more ribs 350, detents, or other features configured to secure an actuator within the sleeve 300. The sleeve 300 may help to hold the cap and base of an actuator together such that the cap and base do not separate during use.

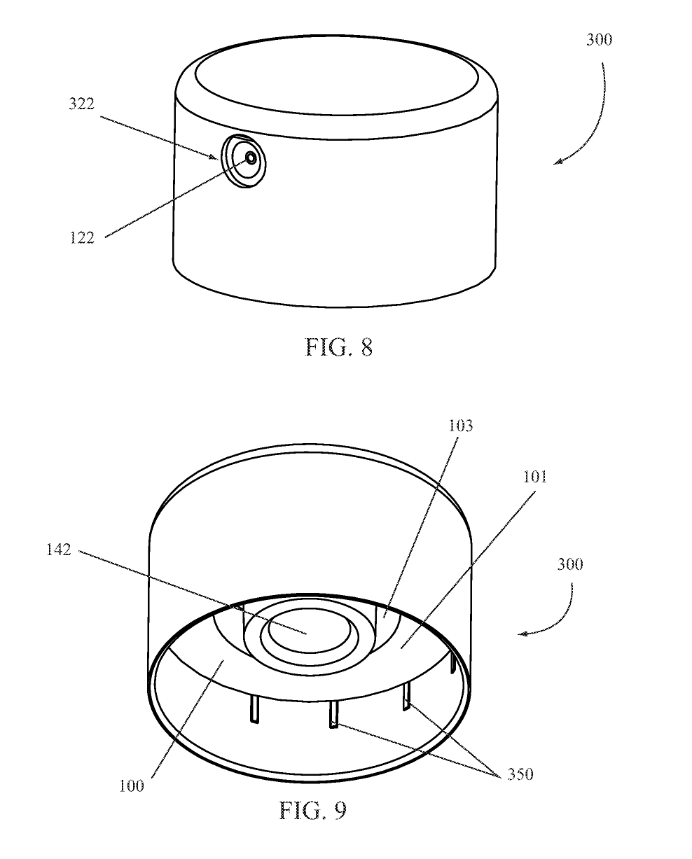

FIGS. 8 and 9 illustrate a sleeve 300 according to embodiments of the invention positioned over an actuator such as actuator 100 or actuator 200 illustrated in FIGS. 1 though 5. For example, an actuator 100 may be positioned within sleeve 300 such that orifice 122 is visible through orifice hole 322. Ribs 350 may hold the actuator 100 within an interior compartment of the sleeve 300. The actuator 100 may include one or more flat surfaces 101 or one or more recesses 103 onto or into which a spring or other biasing device of a pump may positioned. The recess 103 or flat surface 101 may improve the union of a spring or biasing member with the actuator 100.

According to embodiments of the invention, a sleeve 300 may be made of metal, plastic, a resin material, plastic and metal, or any other desired material. For example, a metal sleeve 300 may be used to impart a desired finish to an actuator over which the sleeve 300 is positioned.

According to still other embodiments of the invention, an actuator may be overmolded to provide a head shape over the actuator. The molding of a head shape over an actuator may occur during the molding process or following the molding and assembly of an actuator.

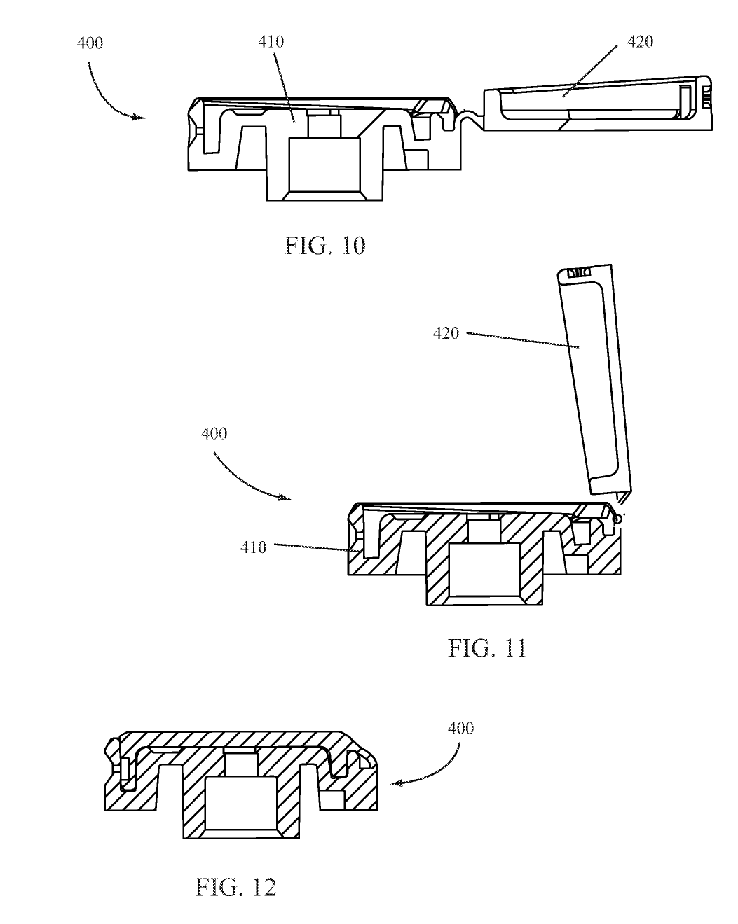

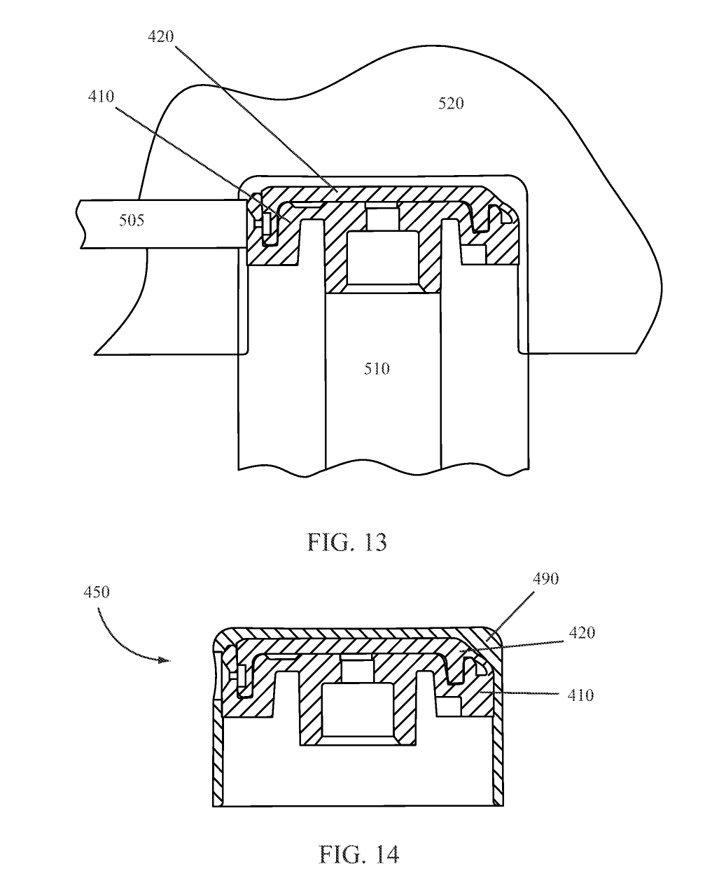

For example, according to certain embodiments of the invention, an actuator 400 having a base 410 and a cap 420 as illustrated in FIG. 10 may be molded as a single part. Once molded, the cap 420 and base 410 of the actuator 400 may be closed or combined as illustrated in FIGS. 11 and 12 to form the actuator 400. Once the actuator 400 is formed, a second molding process may be performed to produce a molded head design over the actuator 400 as illustrated in FIG. 13. During the second molding process, mold slides 505, 510, and 520 may encase hold the actuator 400 in position for an overmolding. The material 490 molded over the actuator 400 thereby forms a shell or sleeve over the actuator and may provide a distinct head shape for the actuator and molded head combination 450 as illustrated in FIG. 14.

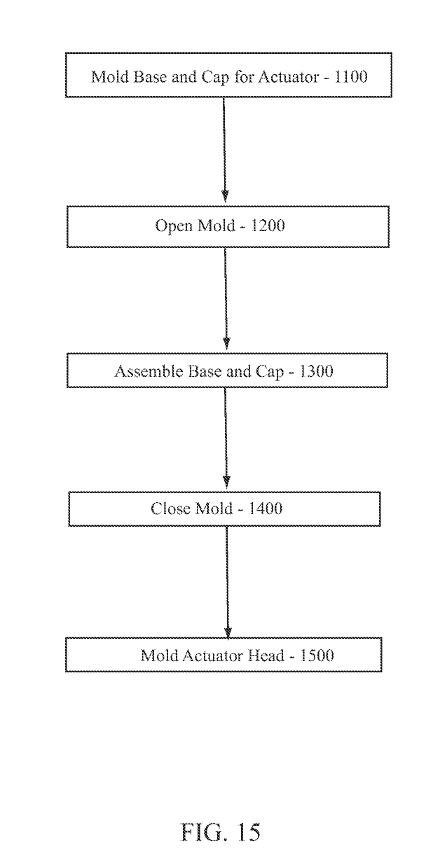

According to some embodiments of the invention, a method for forming an actuator may include the steps illustrated in FIG. 15. In a first step 1100, a base and a cap for an actuator according to embodiments of the invention is molded. The mold is then opened in a second step 1200. The cap and base may then be assembled in a third step 1300. A mold may be closed around the assembled cap and base in a fourth step 1400 and a head shape or form may be defined by the mold closed around the assembled cap and base. In a fifth step 1500 the head shape may be molded around the assembled actuator to produce, for example, an actuator and molded head combination 450 as illustrated in FIG. 14.

In some embodiments of the invention, the method steps illustrated in FIG. 15 may occur in a single mold. For instance, a mold having cavities for both a base and cap of an actuator may be used to mold the base and cap. Upon the opening of the mold 1200, the base and cap may be assembled. Assembly of the base and cap may be accomplished by slides in the mold or by an external mechanism capable of assembling the base and cap in the mold. The mold may then be closed 1300 over the assembled base and cap, leaving room for a new mold shot whereby a distinct head design is molded 1500 to the assembled base and cap. During the molding of the actuator head 1500, slides in the mold may cover the orifice, spin mechanics, or both to prevent the overmolding of the orifice and spin mechanics. For example, the slide 505 illustrated in FIG. 13 may protect the orifice during the molding of the actuator head 1500.

According to various embodiments of the invention, the overmolding of an assembled base and cap may include overmolding using plastic, resin, metal, combinations thereof, or other materials. In addition, the overmolding may be decorated in the molds using sublimation techniques. Further, bi-injection of the overmolding may be desired and performed to create head designs having different materials or different colors.

According to embodiments of the invention, an actuator such as actuator 100 illustrated in FIGS. 1 and 2, actuator 200 as illustrated in FIGS. 3, 4, and 5, the sleeve 300 and actuator illustrated in FIGS. 8 and 9, or the actuator and molded head combination 450 illustrated in FIG. 14 may be connected to a pump which may be connected to a container. When the actuator is actuated, the actuator may impart a force on the pump resulting in the delivery of fluid to a fluid path opening and through the actuator where it is expelled through an orifice.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

1. An actuator, comprising:
a base;
a cap;
a living hinge between the base and the cap, wherein the base, living hinge, and cap are a unitary molded component and the cap is folded over on the base;
spin mechanics defined by the base and cap; and
a sleeve, wherein the base and cap are fitted in the sleeve.

2. The actuator of claim 1, wherein the spin mechanics are molded with the base.

3. The actuator of claim 1, wherein the spin mechanics are molded with the cap.

4-6. (canceled)

7. The actuator of claim 1, further comprising ribs in an interior space of the sleeve, wherein the ribs hold the base and cap in the sleeve.

8. The actuator of claim 1, further comprising:
a container;
a product in the container;
a pump fitted to the container; and
wherein the actuator is fitted to the pump.

9. A method for making an actuator for a pump, comprising:
providing a mold;
molding an integral cap and a base unit having spin mechanics in the mold;
opening the mold;
assembling the cap and base in the mold to form an actuator;
closing the mold; and
molding a material over at least a portion of the assembled cap and base.

10. The method of claim 9, wherein the spin mechanics in the integral cap and base unit comprise spin mechanics in the base.

11. The method of claim 9, wherein the spin mechanics in the integral cap and base unit comprise spin mechanics in the cap.

12. The method of claim 9, wherein the spin mechanics in the integral cap and base unit comprise spin mechanics in the base and the cap.

13-14. (canceled)

15. A head for a pump, comprising:
a molded actuator, comprising:
a base;
a cap; and
a living hinge between the base and cap, wherein the cap is folded over onto the base; and a material molded over the molded actuator and forming a sleeve over the molded actuator.
